(19) United States
(12) Patent Application Publication
(10) Pub. No.: US 2010/0132255 A1
(43) Pub. Date: Jun. 3, 2010

(54) ECO-FRIENDLY VERTICAL PLANTER APPARATUS, SYSTEM, AND METHOD

(76) Inventor: Robert Deloss WEBBER, Kirkland, WA (US)

Correspondence Address: KATHLEEN T. PETRICH, GRAHAM & DUNN PC, 2801 ALASKAN WAY, SUITE 300 - PIER 70, SEATTLE, WA, 98121-1128, US

(21) Appl. No.: 12/492,595

(22) Filed: Jun. 26, 2009

(51) Int. Cl. A01G 9/02; A01G 25/00; A01G 13/04

(52) U.S. Cl. 47/29.1; 47/82; 47/86; 47/81

(57) ABSTRACT

An eco-friendly vertical planter apparatus, system, and method that allow a user to grow vegetative plant matter with minimal water and soil. The vertical planter apparatus includes a base and at least one central planting unit having its own base and at a least one sidewall to form a container for holding plant matter and soil. The vertical planter also includes a moisture-retentive wick, such as a cotton-woven braid, having at least two ends. One end of the moisture-retentive wick is placed within the container. In use, soil is placed within the container atop at least one end of the wick and plant matter is planted within the soil substantially adjacent the moisture-retentive wick. Optional features include modular central planting units, multiple external planting tubes, a thermal mass to retain heat to plant matter roots, a water reservoir, a cloche/cover to simulate green-house effect, and dark or light colored central planting units or tubes depending on the type of plant matter being grown.

### TECHNICAL FIELD

The invention relates generally to vertical planters. More specifically, the present invention relates to a vertical planter apparatus, system, and method having a moisture-retentive wick that reduces the amount of water required to sustain plant growth. The present invention also relates to a thermal mass to retain heat to plant roots within the planter apparatus.

### BACKGROUND OF THE INVENTION

Food sources have grown scarcer as the population has exploded. Arable land to sustain populations has decreased. Further, water is projected to become the most valuable and scarce resource.

Across the globe, populations have left traditional agricultural areas and farms and migrated to already dense cities. This means that food needs have concentrated far from food producing areas. It is currently estimated that in the United States, daily food sources average over 1,500 miles from the consumer. To produce, store, ship, and sell produce remotely has a great economic and nutritional impact. It should come as no surprise that plant food is much more nutritious closer to the source as opposed to being weeks away and up to thousands of miles away from end consumer.

While home gardening is making a come-back over the general population, and never went out of fashion for those that love gardening, more people live in urban areas that do not always provide adequate access to planting areas. This is particularly true of urban condominium and apartment dwellers. However, the relatively small numbers of available urban “p-patches” have wait lists.

Vertical planters and vertical hydroponic planting systems for planting vegetable, fruit, and flower gardens have been known for quite some time. Examples of these may be found in Mason, Jr., U.S. Pat. No. 4,779,378 entitled “Integrable, Modular Stackable Multi-Plant Holder”; Harvey, U.S. Pat. No. 4,986,027 entitled “Hydroponic Growth System”; Swearengin et al., U.S. Pat. No. 5,276,997 entitled “Planter with Built-In Water Distribution System.” Certainly, the traditional clay strawberry planter with externally projecting openings is well known to even the most garden-adverse person. However, the hydroponic systems are cumbersome and unnecessarily complicated. The known vertical planters do not account for limitations on available water or lack of accessible power. Further, many urban dwellers are away from their premises for long periods of time so that the system and method of growing must be fairly hearty and amenable to urban populations that may not be accustomed to regular care of good gardens.

If such a water conserving, easy to use, small footprint planter would be available, the application would not only be worthwhile for urbanites and suburbanites, but could also be used as a means for large scale plant food production in areas where soil and water are unavailable or at a premium or for significantly displaced populations (e.g., relief aid).

### SUMMARY OF THE INVENTION

The present invention is directed to eco-friendly vertical planting apparatus, system, and a method of growing sustainable food. The invention is particularly useful where there is little water or natural good soil for agriculture, or for impervious surfaces, or where land is at a premium, or where users have little time or access to gardening for sustainable food. The system is environmentally friendly as the planter components can be made of inexpensive and/or recyclable, lightweight materials. The planter itself is designed to be readily transportable and utilizes a relatively small space or “footprint.”

According to one aspect of the invention, the vertical planting apparatus includes a base and at least one central planting unit that can be adapted to mount atop of the base. The central planting unit has a lower region and at least one sidewall that together form a container of a size and shape to hold soil and plant matter. In one embodiment, the central planting unit may have multiple tubes or ports that extend or branch outward and each tube is of a shape to hold soil and plant matter. Such a multiple tube central planting unit may be stacked atop another multiple tube central planting unit to resemble a vertically-extending “tree” with multiple “branches,” each “branch” with an upper opening that is open to ambient air. In one form of the invention, at least one moisture-retentive wick is placed in the container where the soil and plant matter would be placed in use. The wick retains and transmits water (moisture) and can significantly reduce, but does not completely eliminate, future water needs during the plant cycle of growth by capturing and recycling drainage.

According to another aspect of the present invention, the vertical planting apparatus may include a thermal mass unit that is generally positioned between the container and the base of the vertical planting apparatus. The thermal mass unit is used to generate and retain heat near the plant matter (and particularly plant roots) when the vertical planting apparatus is in use.

Another aspect of the invention includes the combination of the thermal mass unit and the moisture-retentive wick. The moisture-retentive wick may be added to the containers below the thermal mass for optimal growing.

The invention may further include a water reservoir between the container and an outer edge of the central planting unit. One end of the moisture-retentive wick may be placed within the reservoir and the other end of the moisture-retentive wick can be placed within the container. In use, soil is positioned atop of the wick and adjacent plant matter. Thus, plant matter can have access to necessary moisture with little human effort or intervention, despite limited access to water or fancy hydroponics systems.

The optional water reservoir discussed above may be used in connection with the thermal mass unit.

Drain holes may be added to the central planting unit or base, or both to drain overflow of moisture (water).

In another aspect of the invention utilizes light and dark materials as a means to enhance growth, depending on the type of food that is being produced. For example, dark-colored central planting units are tubes would be best for the growth and production of fruit-bearing plants, including tomatoes. While light-colored central planting units and tubes would be best from the growth and production of leafy greens.

In another embodiment, green-house effect may be given to the overall vertical planting apparatus by covering the vertical planting apparatus with a cloche or cover, when the vertical planter is in use with soil and plant matter. The cloche/cover may be made of a thin plastic material that can be gathered at the base and provide sufficient heat to the plant matter for extending the growing season.

The present invention apparatus, system, and method of vertical planting can be easily adapted for growing organic vegetables and other food items for urban dwellers (especially those not accustomed to being able to provide traditional plant care for gardens), as well as those in harsh environments or lacking in good arable soil. Further, the lightweight and portable vertical planting apparatus can be readily growing healthy organic food for necessary relief aid close to the relief camps with minimal soil and water.

These and other features and advantages will be more understood from reviewing the various figures of the attached drawings, the Description of the Drawings, and the Detailed Description of the Invention.

### DESCRIPTION OF THE DRAWINGS

Like reference numerals are used to designate like parts throughout the several views of the drawings, wherein:

FIG. 1 is a pictorial view of a first embodiment of the present invention, namely, an assembled modular vertical planter apparatus having a base and one or more central planting segments;

FIG. 2 is an assembly pictorial view of FIG. 1;

FIG. 2A is an assembly pictorial view like FIG. 1 except illustrating a connector member that can function as an additional planter member or a thermal mass unit;

FIG. 3 is an enlarged pictorial view of a central planting segment;

FIG. 4 is a top view of FIG. 3;

FIG. 5 is an enlarged view of the connector member illustrated in FIG. 2A;

FIG. 6 is an enlarged view of a central planning segment illustrated in FIG. 3 except only showing the main structural tube and one adjacent tube of an exemplar central planting unit and further showing a moisture-retentive wick in cutaway;

FIG. 7 is a pictorial view of a vertical planter apparatus of FIG. 1 shown in use with various plant (food) growing in and outside of the central planting sections and added weight applied at the base;

FIG. 8 is a partial section view of an alternate embodiment central planting segment and illustrating the vertical planter apparatus in use with plantings having roots, the wick, and an optional moisture-storing reservoir;

FIG. 9 is a pictorial partial assembly view illustrating another embodiment of the present invention illustrating where the wick may be configured within the central planting unit in combination with a thermal mass unit, itself positioned above the wick shown in cutaway;

FIG. 10 is a section view of an assembled thermal mass unit and central planting unit of FIG. 9 except illustrated in use with plant matter, soil, moisture-retentive wick, thermal mass unit, and reservoir;

FIG. 11 is a pictorial partial assembly view illustrating yet another embodiment where an additional wick may be configured such that one end of the additional wick is in the central planting unit passing through the reservoir overflow hole to the outside;

FIG. 12 is a pictorial view of the vertical planter apparatus of an alternate embodiment of the present invention in which a transparent cloche is placed over the vertical planting apparatus to simulate a green house when heat is needed to maximize plant production or ambient temperature is not optimal;

FIG. 13 is a pictorial assembly view of a base and an optional base collar for growing of deep root crops;

FIG. 14 is a pictorial view of another alternate embodiment of the present invention illustrating a different central planting and base configuration;

FIG. 15 is a section view of FIG. 14 taken substantially along lines 15-15, and further illustrating a system with plant matter, soil, moisture, a wick, reservoir, and a thermal mass unit; and

FIG. 16 is a pictorial view showing a method of planting an orchard atop an impervious surface, such as a roof as illustrated, and better illustrating the application of light and dark vertical planters in use with different type vegetative plant matter.

### DETAILED DESCRIPTION OF THE INVENTION

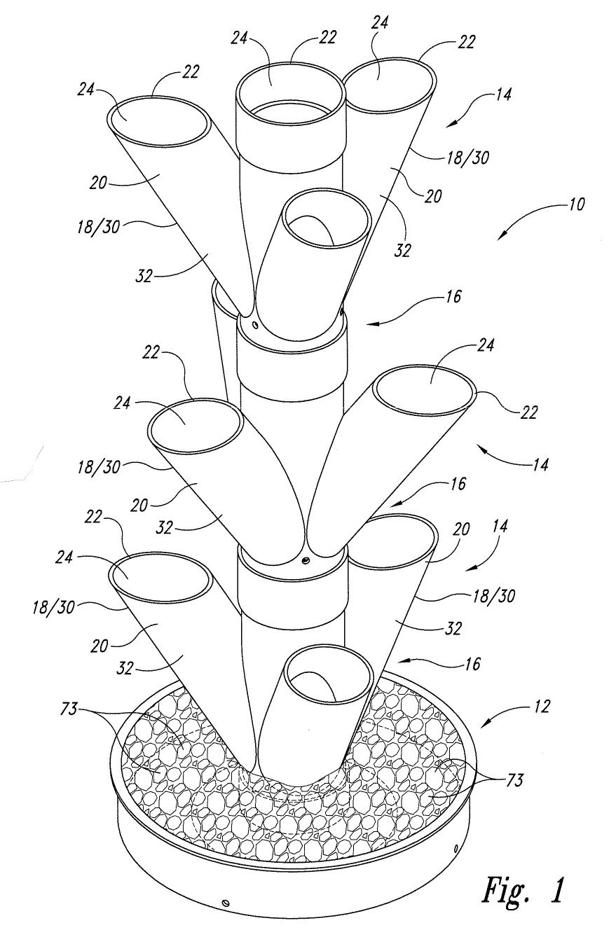

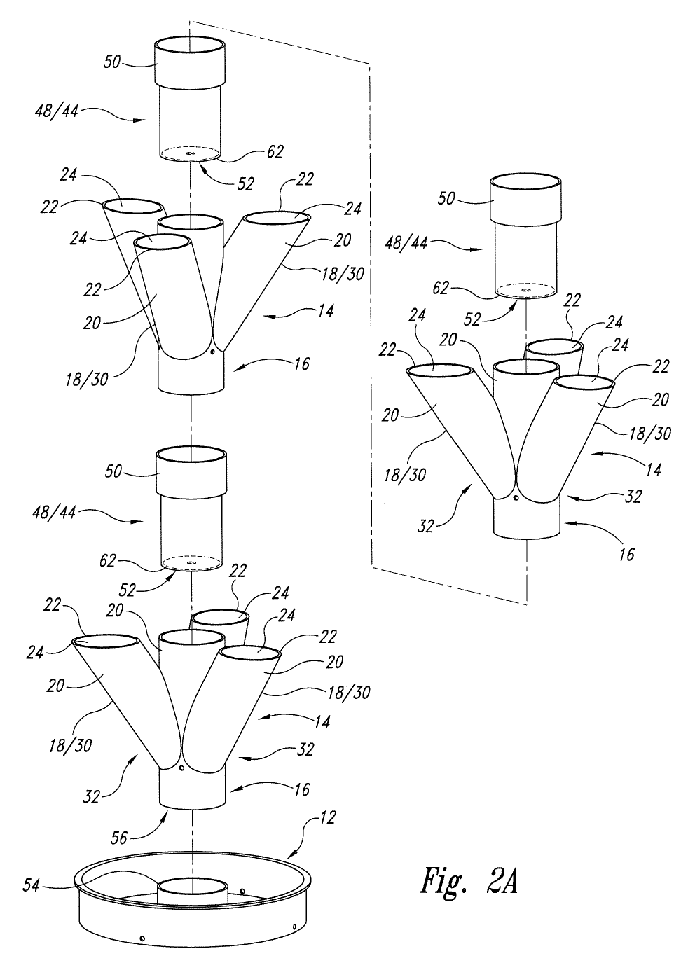

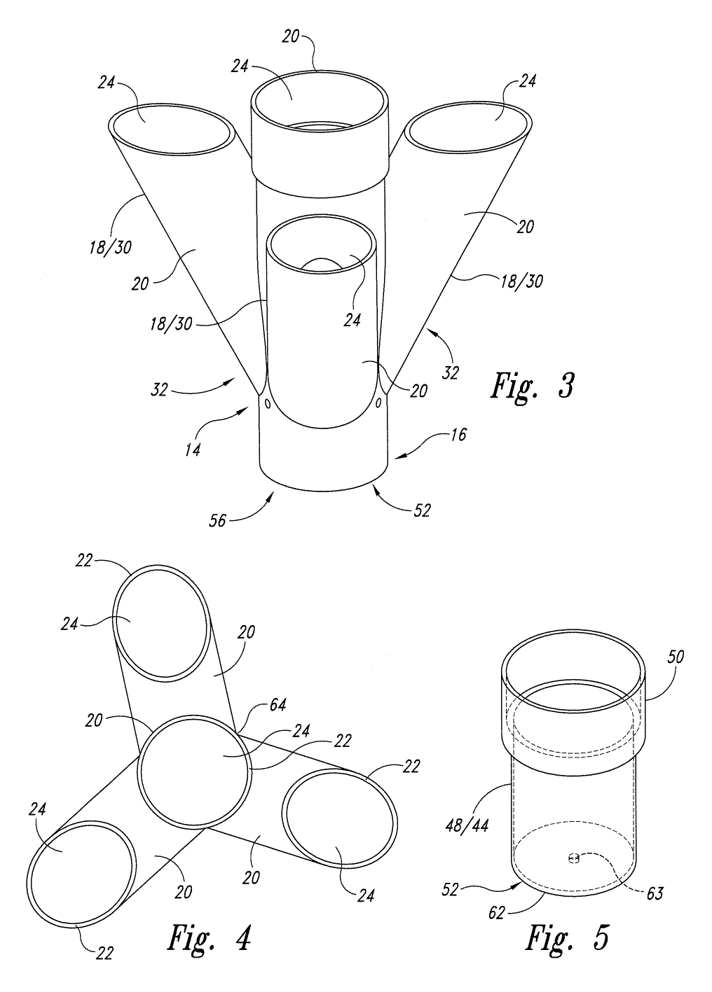

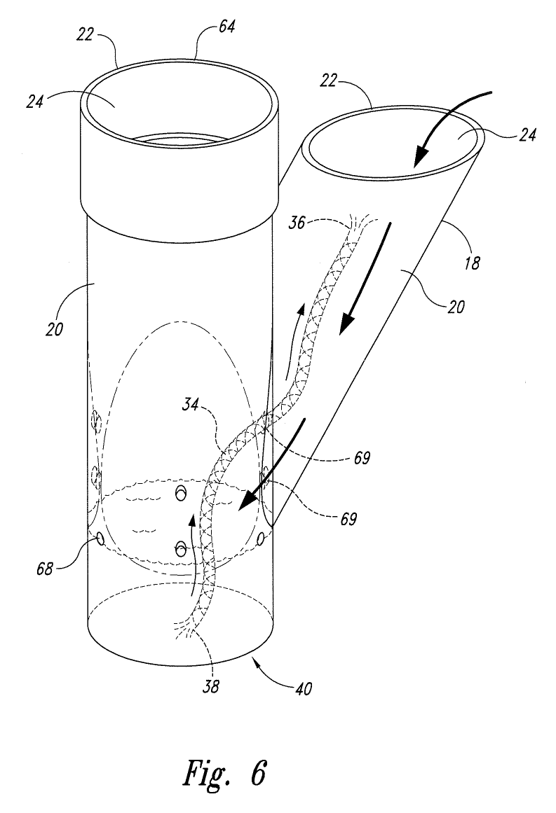

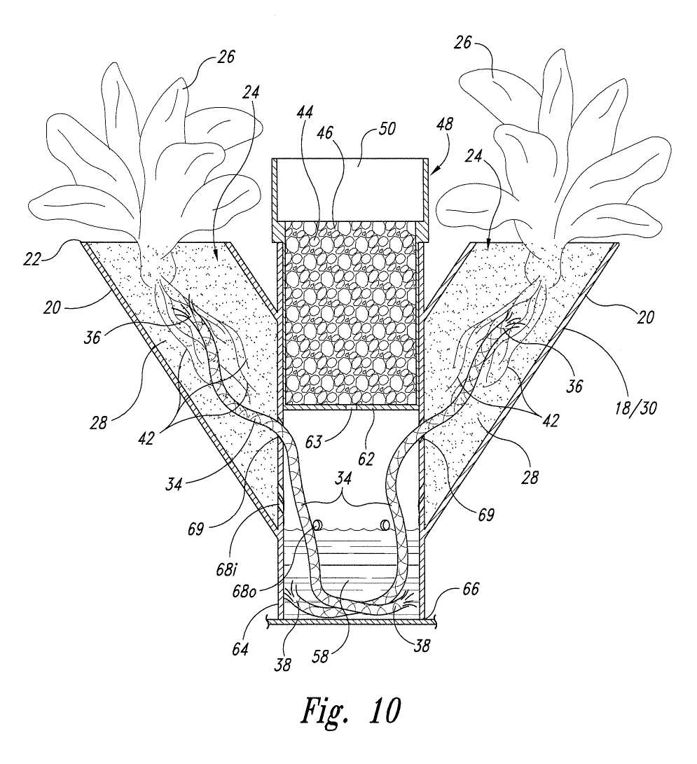

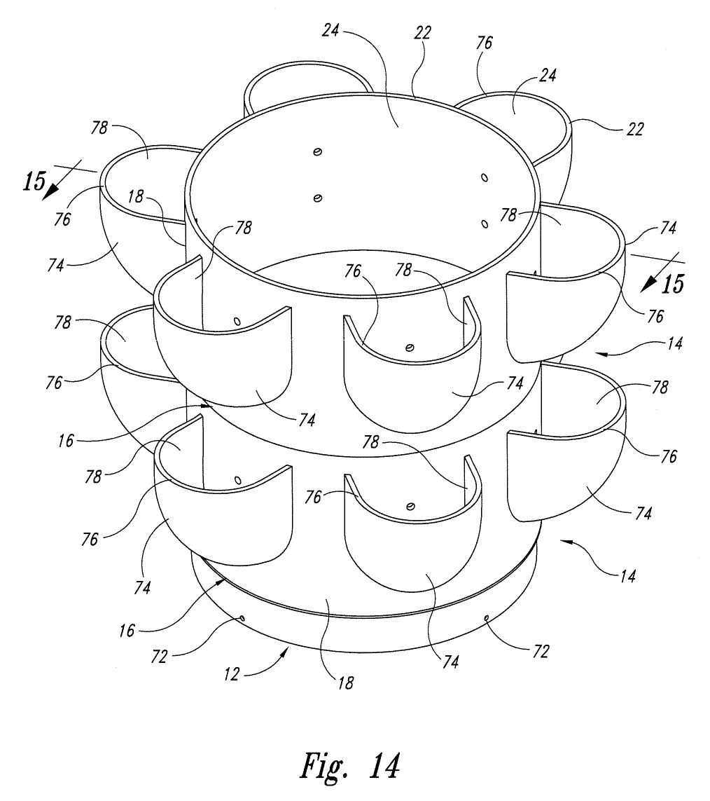

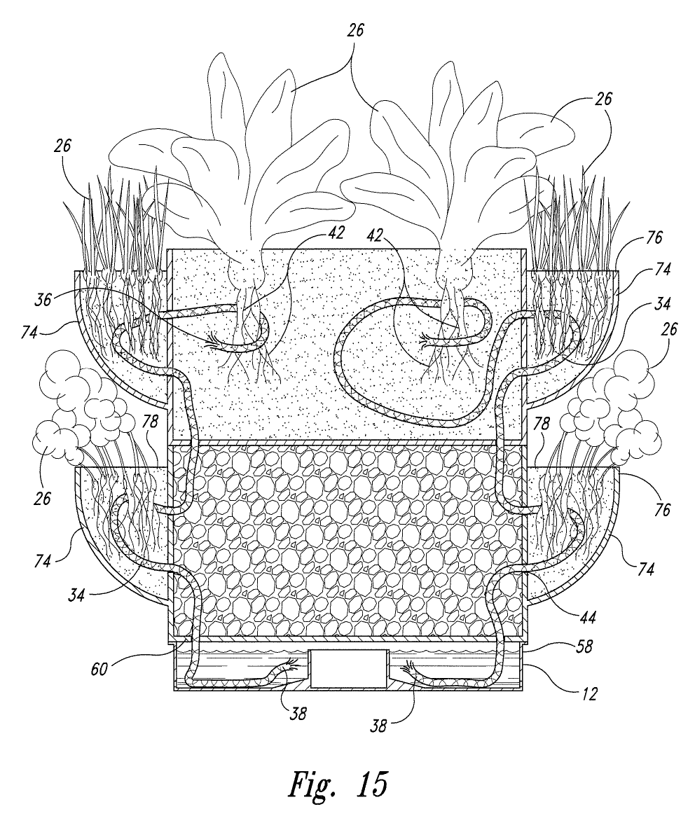

Referring to FIGS. 1 to 16, the present invention is directed to an eco-friendly, “small footprint” vertical planter apparatus 10 that includes a base 12 and at least one central planting unit or planter segment 14. In use, central planting unit 14 is placed atop of base 12. Central planting unit 14 includes a lower portion 16 and a sidewall 18 that may be comprised of one large (FIG. 14-15) or plurality of tubular members 20 (FIGS. 1-7 and 9-12). Each lower portion 16 and sidewall 18 forms a container 22 with an opening 24. Each container 22 is of a size and shape to hold plant matter 26 and soil 28 (see FIG. 10). In the embodiments of FIGS. 1-7, and 9-12, each tubular member 20 itself comprises a sidewall 30 and a lower region 32 that forms container 22 of sufficient size and shape to contain and nourish plant matter (plants, sprouts, or seeds) 26 and soil 28.

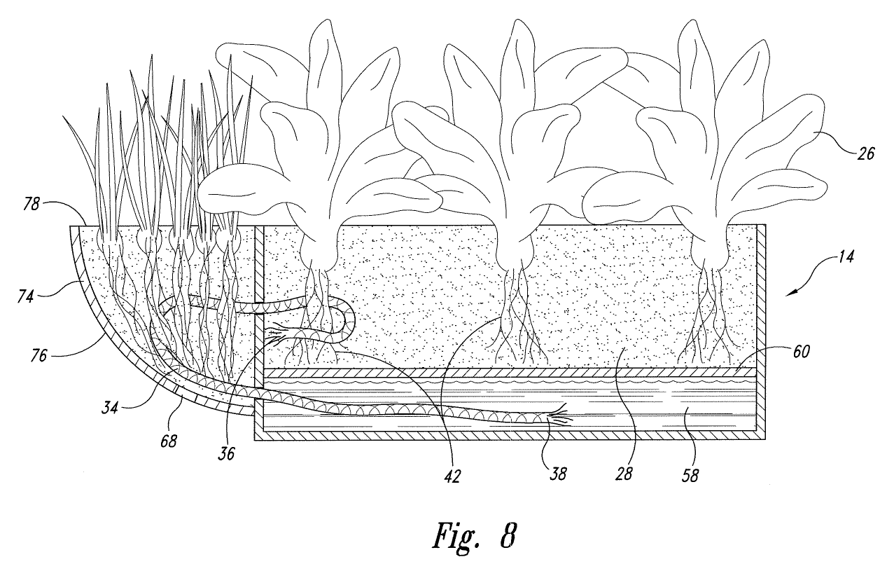

Now referring particularly to FIG. 6, a moisture-retentive wick 34 having at least two ends 36, 38, may be placed in the central planting unit 14, including some or each tubular member 20. Wick 34 may be made of cotton or twine and may be braided. Wick 34 functions to store and retains moisture (water) and reduces the need for extensive additional watering during the growing period by disseminating retained water back into the soil near the plant roots or seeds over time. A portion of the wick may be positioned in a generally upright relationship relative to container 22. One wick end 38 may be positioned near a bottom 40 of container 22. In one form of the invention, the other end of the wick 36 would be mostly or completely covered by soil 28. In use, moisture-retentive wick 34 would be positioned generally approximate plant roots 42 (as illustrated in FIGS. 8 and 10), which will be discussed in more detail below.

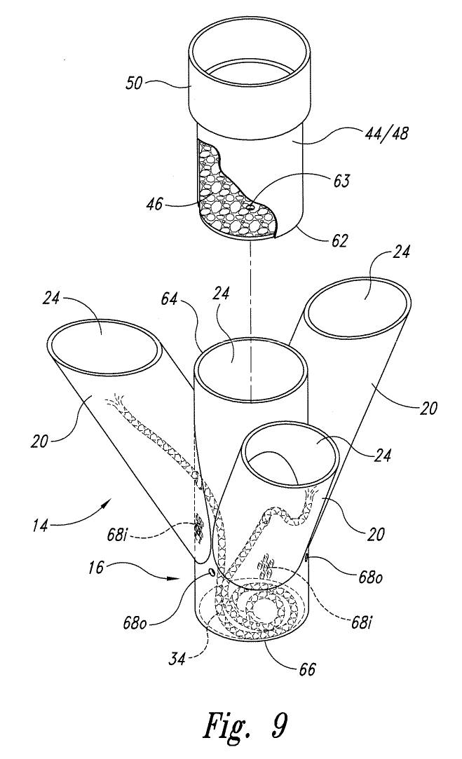

An optional thermal mass unit 44 (such as the unit shown in FIG. 9 with thermal medium 46 shown in cutaway) may be added to the vertical planting apparatus 10 as part of one of the central planting units 14 (FIG. 15), positioned above base 12 (not illustrated), between base 12 and the central planting unit base 24 (not illustrated), or in a separate container, such as shown with optional connector 48 (FIG. 10). The thermal mass unit functions to absorb heat during daylight and to stimulate growth, particularly for fruits and flowers. The thermal mass medium may be gravel or other heat absorbing medium (e.g., clay, sand) can be used.

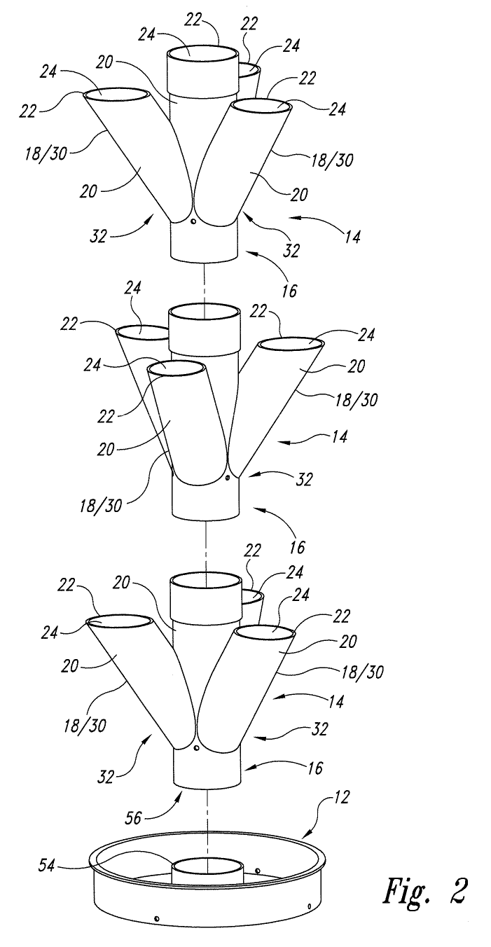

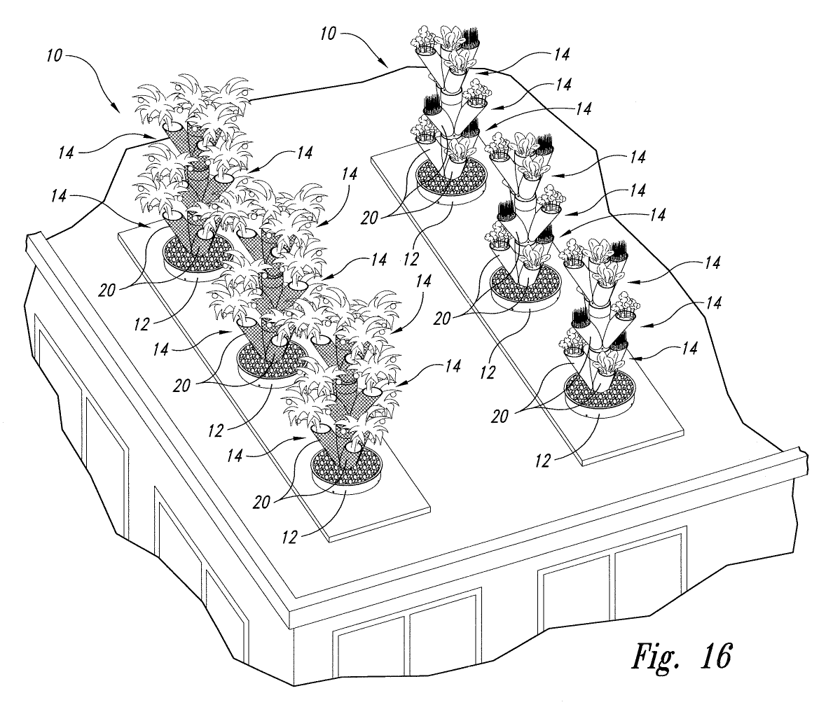

Referring particularly to FIGS. 2A, 5, 9-10, and 16 optional connector 48 may be used to provide height and interconnection between two or more central planting units (FIGS. 2A, 16), may function as upper planting tube container (FIG. 16), or may itself function as the thermal mass unit (FIGS. 9-10), as discussed above. The connector 48 may have a bell or collared top 50 and a slightly tapering base 52 that can readily be inserted within a bell or collared top member of an adjacent connector or central planting unit. Base 12 may itself also have a collared top 54 of a size to receive a base member 56 of a central planting unit 14 of connector 48 as illustrated in FIG. 2A.

Referring to FIGS. 8 and 10, another aspect of the invention combines the moisture-retentive wick 34 with a moisture (water) reservoir 58. The reservoir may be created by a substantially water-tight bottom 60 (FIG. 8) or a reservoir created by the insertion of connector 48 into central planting tube member (FIG. 10). One end of the wick is placed in the reservoir 58 and the other end of the wick is with the plant container, preferably positioned adjacent plant roots. When the wick is used with the reservoir, the wick may also function to siphon water from the reservoir through capillary action and move water upwards in the container near the plant roots. While there are many factors that can contribute to the need for watering, such as temperature, humidity, sunlight/photosynthesis, evaporation surface area, and soil drainage, early experiments suggest water savings with the wick and reservoir combination up to 50%. The water savings also necessarily provides a bonus benefit in labor savings, which would be particularly useful for large scale vegetative planting using the method and system described herein.

Alternatively, the invention can include the combination of the moisture-retentive wick and thermal mass. This is best illustrated in FIGS. 9 and 10. The connector 48 is illustrated as also functioning as the thermal mass unit 44. The connector/thermal mass unit 48/44, which itself has a bottom 62 and may include a drain hole 63, is inserted within central tube 64. The thermal mass is generally above most of the wick. In one embodiment, the shorter connector bottom 62 leaves a natural reservoir 58 between the bottom edge of the connector 62 and the lower edge of the 66 of the central tube 64. One end of the wick or wicks is positioned in this created reservoir between the connector and the central tube. The other end of the wick may be positioned near the plant matter 26, and particularly plant roots 42.

Referring to FIG. 9, drain holes 68 may be added to the tubes/central planting units 14 to provide overflow if there is too much moisture (water). These drain holes 68i (interior holes) and 68o (outside holes) may be near the bottom of the container 40 so that plant roots 42 are not exposed to too much water. Wick holes 69 (see FIG. 10) may be added to the container to better place the wick relative to the reservoir and plant roots.

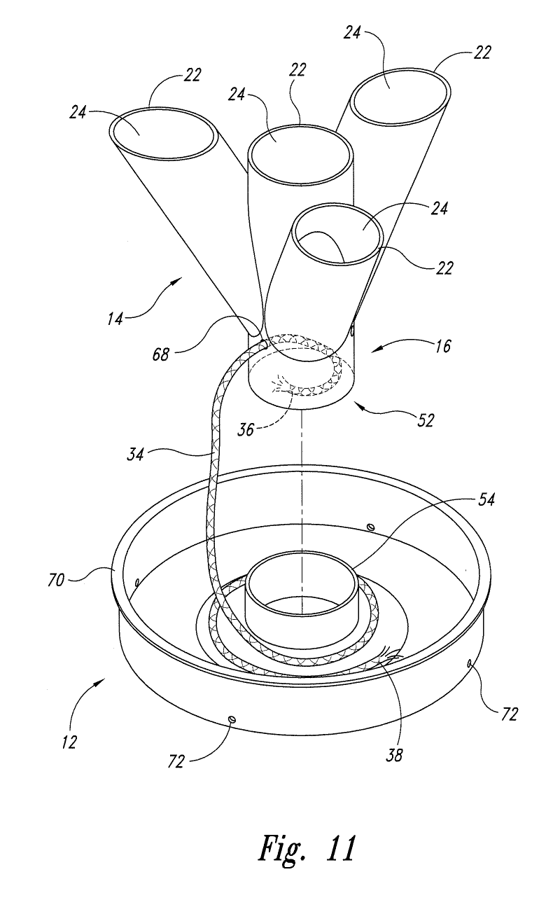

Referring now to FIGS. 9-10, a plurality of wicks 34 may be configured within the various containers of a central planting unit 14 with one end 36 being positioned near plant roots/plant matter and the other end (now joined with the ends of wicks of other adjoining tubes) and placed within the bottom of the container 40 or reservoir 58, as shown. An alternate is illustrated in FIG. 11 in which one end 36 of wick 34 is positioned within the base of a central planting unit 14, exits through a drain hole 68, and the other end 38 of the wick 34 is positioned within base 12. In FIG. 11, the water reservoir may be part of the collared top 54 of the base and a base pan 70.

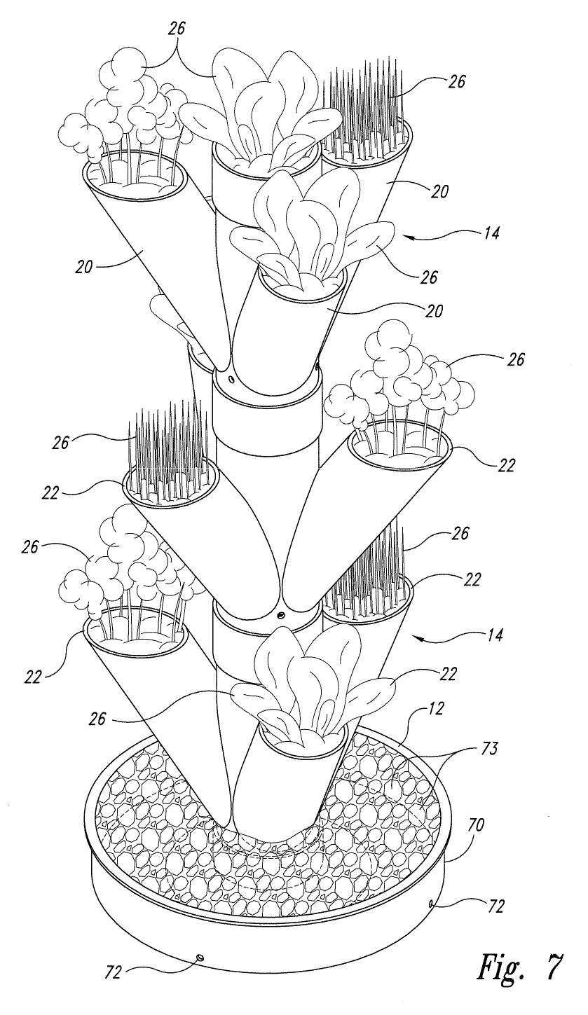

Base 12 may also have drain holes 72 for the same reason related to overflow as those designated as “68.” The base may be given added weight, such as gravel 73 as illustrated in FIG. 7, to support a potentially heavy vertical structure. One of ordinary skill would know that the base would need to be sufficiently weighted if there is a large number of heavy soil plantings and/or multiple tiers of central planting unit, not to mention the addition of thermal mass units. Conversely, the base itself may be made from a heavier material such as concrete or wrought iron with a stanchion mount to adapt the base of the central planting unit (not illustrated).

Referring now to FIGS. 8, 13-15, central planting unit 14 may be configured more as a cylinder or large tube with external “ports” 74 and that central planting unit 14 may stack directly atop of the base 12. Ports 74 are intended to function like tubes 20, and, like tubes 20, have at least a partial sidewall 76 and forming at opening 78 to contain soil and plant matter. This configuration is helpful for plants that need more soil and area to grow, e.g., tomatoes. This embodiment may also accommodate a moisture-retentive wick 34, water reservoir 58, and/or thermal mass 44. In FIG. 8, just the wick and reservoir are illustrated. In FIG. 15, wick (in multiple forms), reservoir, and thermal mass unit are all illustrated.

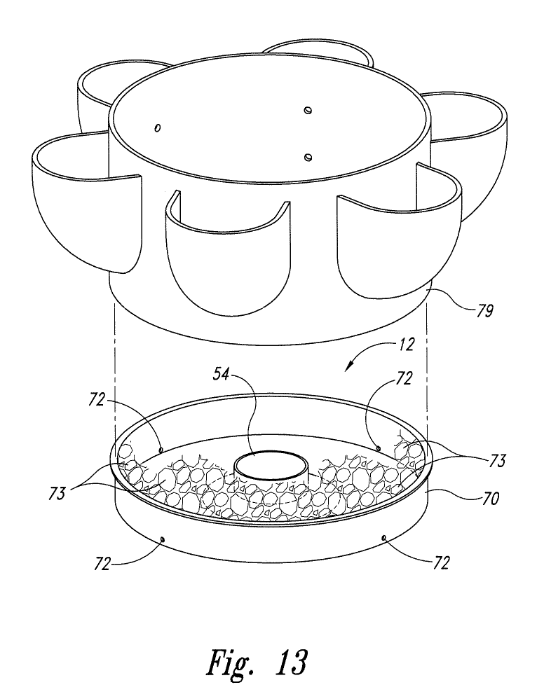

FIG. 13 illustrates a collar 79 to go about the base 12 for deep root crops or larger plants or shrubs. This collar can be used with the central planting units embodied in FIGS. 1-12 or an extension of base 12 to which a central planting unit embodied in FIG. 14 may rest atop for purposes of thermal mass and/or moisture reservoir.

While many materials may be used, the particular tubular version and base is preferably made through injection molding. With the connector member, there may be as little as three main structural components of the vertical planting apparatus, which keeps costs low and leads to easy packing/assembly. Ideally, the central planting units are lightweight and can be interchanged or adapted to new configurations with little trouble. Thus, the vertical planting apparatus of the present invention is amenable to modularity. Another option is that the tubular members are made from 4 inch PVC drain pipe or from recycled materials, such as corrugated papers or fibers.

Now referring to FIGS. 7 and 15, the invention can be adapted to a system for growing plants/vegetative matter. The vertical planters discussed above can be adapted with soil, moisture, and heat to grow vegetative food with little access to arable land or large water source. A wide variety of vegetables from leafy greens, to tomatoes, or root vegetables (carrots, onions, beets), can be grown on otherwise impervious surfaces or otherwise inhospitable growing surfaces such as on a roof top or a deck. Further, since the system may be assembled from very lightweight and modular components, the planters can be easily shipped, readily assembled, and planted in very harsh or otherwise austere conditions, including aid relief camps.

A base and at least one central planting unit are assembled. A moisture-retentive wick, such as discussed above, is added to at least one container. A relatively small amount of nutrient rich planting soil is added to the container. Plant matter (seeds or plant starts) are inserted into the soil of within the tube container or central planting unit container such that plant roots that are generated from the seeds/plant starts have room to expand downwards into the container and the that the seeds/plants will be exposed to heat/ambient light (sunshine if outdoors, heat lamp if inside). A thermal mass unit, having thermal material, such as gravel or sand or other granular material, may be added to the combination of the contained plants and soil. A reservoir may also be added to the combination with the wick or with the wick and thermal mass.

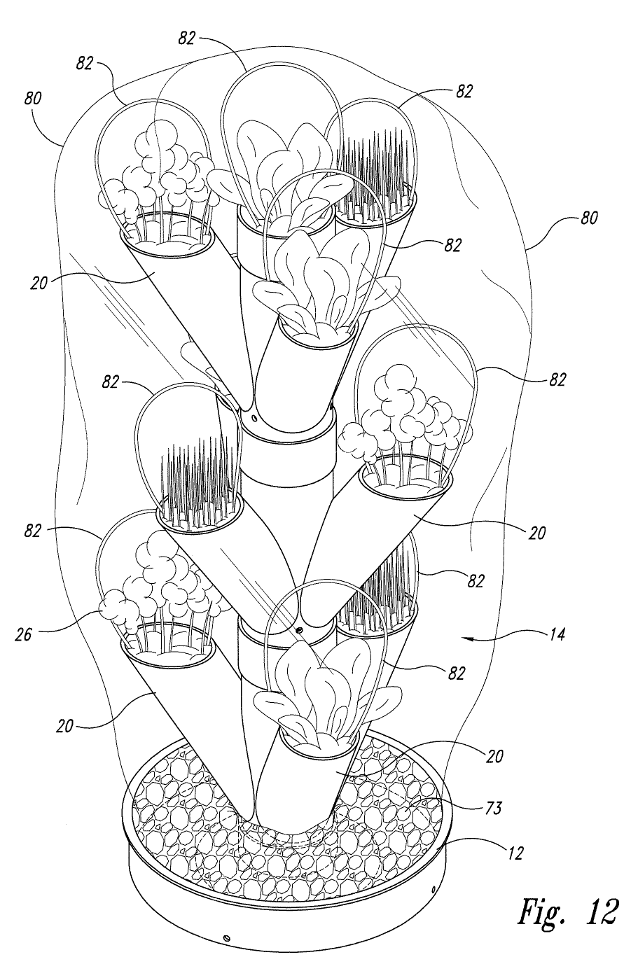

A cloche 80, as illustrated in FIG. 12, may be placed over the vertical planting system to replicate green-house effect in the event that the plant matter requires more heat. Cloche or cover 80 may be transparent plastic bag that may be propped up over the plants through the addition of a series of bent looped wires 82 that are inserted into openings 24. The cloche may be gathered at base 12. Bent wires 82 may also be used to assist with staking certain plants, such as tomatoes, when the plant starts sprout and attain sufficient growth where some additional vertical support is desired.

Referring now to FIG. 16, the vertical planting apparatus and system of the present invention can be adapted for a method of growing vegetative matter. In addition to the discussion above, the method may include larger scale vegetative growing in which rows of vertical planters are assembled for sustainable food harvesting. Such rows can be placed atop of tar roofs as part of green roof gardening steps and be highly productive in two ways. First, being placed atop of a roof provides more direct access to sunshine and therefore more opportunity and likelihood of success to grow food-producing vegetative plants. Second, tar roofs (or other impermeable surfaces) can heat up greatly in direct sunshine. The energy that is required to cool the building and occupants can be substantial depending on the climate and season. However, rows of vertical planters described in this invention may significantly reduce the overall temperature of the roof (by analogy to green roofs, studies have shown that a tar roof in hot sun can be in the range of 150° F., whereas the roof temperature in same conditions but with a green roof can drop into 80° F. range). Such a temperature drop has been shown to decrease the need for air conditioning, thus, green roofs (and, by analogy, the present vertical planters) have more ecological benefits than merely food production that can be readily and inexpensively grown at the consumption source with reduced water and soil requirements.

Color of the central planting units/tubes may be used to assist with plant growth. For example, using dark PVC tube or other dark material absorbs heat and will assist fruit-bearing plants and flowers. Whereas, white PVC tubes or other light color materials for the central planting units will assist in the cultivating leafy greens because such plant matter tends to grow well without a large amount of heat (sunshine) and will bolt to seed with too much heat and light.

According to early experiments, vegetative plants grown under the method and system described herein can be ready for harvest up to 10-20% earlier than normally anticipated. Thus, not only does the present invention provide an easy to use and energy savings planting system for growing vegetative matter, but it also provides a benefit of a reduced harvesting time. It is anticipated that in certain climates and conditions, an additional growing cycle can be inserted thereby increasing high quality, local food production.

Pests may be more easily controlled with the method and system of the present invention. Ground pests, such as snails and slugs, can be more readily controlled as the plant roots are not planted directly into the ground. Flying pests, such as aphids, may be more readily controlled because the vegetative growth is very easy to see and access. The present invention lends itself to organic pest control, as opposed to resorting to a full “chemical assault,” because the method and system is fully contained.

The illustrated embodiments are only examples of the present invention and, therefore, are non-limitive. It is to be understood that many changes in the particular structure, materials, and features of the invention may be made without departing from the spirit and scope of the invention. Therefore, it is the Applicant's intention that his patent rights not be limited by the particular embodiments illustrated and described herein, but rather by the following claims interpreted according to accepted doctrines of claim interpretation, including the Doctrine of Equivalents and Reversal of Parts.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A method of growing plants in a vertical container, the method comprising:
providing a vertical planter having a base, at least one central planting unit adaptable to mount atop said base through a lower outer edge; said central planting unit having a base and at least one sidewall forming at least one container with an opening of a size and shape to hold soil and plant material, and at least one moisture-retentive wick having at least two ends;
providing planting soil to substantially fill the at least one container;
providing desired plant matter;
placing one end of moisture-retentive wick near bottom base of container and soil atop moisture-retentive wick;
creating a well within the soil and placing plant matter within the well and generally adjacent the moisture-retentive wick;
providing sufficient moisture to moisten soil, plant matter, and at least the soil-submerged end of the wick;
expose said vertical planter, soil, and plant matter to ambient air and heat.

21. The method of claim 20 further including a thermal mass between the container of the central planting unit and the base of the vertical planter.

22. The method of claim 20 wherein each central planting unit is modular and stackable atop of the base to provide various configurations.

23. The method of claim 20 wherein each central unit has at least one external tube, each said tube includes a sidewall and an opening to form a container of a size and shape to hold soil and plant material such that soil and plant matter is provided into each external tube.

24. The method of claim 20 wherein said central planting unit container further includes a reservoir formed between the container and an outer edge of the central planting unit that is atop the base, wherein one end of the moisture-retentive wick is positioned within the reservoir and moisture is added to the reservoir.

25. The method of claim 20 wherein green-house effect is imparted to the plant matter by placing a cloche atop of the vertical planter.

26. The method of claim 20 wherein the at least one central planting unit is made of a light colored material.

27. The method of claim 20 wherein the at least one central planting unit is made of a dark colored material.

28. The method of claim 20 wherein there an orchard is created through the positions of several vertical planters adjacent each other.

29. A method of growing plants in a vertical container, the method comprising:
providing a vertical planter having a base, at least one central planting unit adaptable to mount atop said base through a lower outer edge; said central planting unit having a base and at least one sidewall forming at least one container with an opening of a size and shape to hold soil and plant material, and at least one moisture-retentive wick having at least two ends;
providing planting soil to substantially fill the at least one container;
providing desired plant matter;
providing a moisture-retentive wick having at least two ends;
means for placing at least a potion of the moisture-retentive wick within the container;
means for placing plant matter within the well and generally adjacent the moisture-retentive wick;
providing sufficient moisture to moisten soil, at least at portion of the wick, and plant matter, and
expose said vertical planter, soil, and plant matter to ambient air and heat.
